(19) United States
(12) Patent Application Publication
(10) Pub. No.: US 2013/0259561 A1
(43) Pub. Date: Oct. 3, 2013

(54) COLLAPSIBLE TUBULAR ROD

(71) Applicant: Hsin-Yuan Lai, Taichung City (TW)

(72) Inventor: Hsin-Yuan Lai, Taichung City (TW)

(21) Appl. No.: 13/431,112

(22) Filed: Mar. 27, 2012

(51) Int. Cl. F16B 7/00

(52) U.S. Cl. 403/33

(57) ABSTRACT

A collapsible tubular rod includes a socket body having an inner friction surface adjacent to one end thereof, and a tubular rod body coupled to the socket body and having a plurality of rod segments configured to be end-to-end engageable such that the rod body is convertible from a collapsed state to an assembled state in which the rod segments are successively engaged with one another by pulling of a connecting cord led through the socket and rod bodies. A releasably clamping member has a radially expandable tubular plug mating with and axially movable relative to the inner friction surface so as to be displaced from a normal position for gripping the connecting cord to an expanded position for tension adjustment of the cord when an actuator is actuated manually to move axially or radially.

### BACKGROUND OF THE INVENTION

1. Field of the Invention

This invention relates to a tubular rod, more particularly to a collapsible tubular rod, such as an avalanche probe for avalanche rescue, which is capable of being recovered into an in-line arrangement.

2. Description of the Related Art

Referring to FIGS. 1 and 2, a conventional collapsible avalanche probe 1 is shown to include a socket body 11 and a plurality of tubular rod segments 12 configured to be end-to-end engageable by plug connections 121 such that the probe 1 is convertible between a collapsed state and an assembled state in which the tubular rod segments 12 are coaxially and successively engaged with one another to be of an in-line arrangement. A connecting cord 13 is led through the socket body 11 and the tubular rod segments 12, and has a pulling end 15 which can be tensed to keep the probe 1 in the assembled state. A clamping member 14 is provided to fix the connecting cord 13, and has a mating body 140 fitted into the socket body 11, two resilient legs 141 biased to be retained on a rear end of the socket body 11, and two screw nuts 142 retained on the connecting cord 13 and threadedly engaged with a screw bolt 144 such that relative threaded movement of the screw nuts 142 permits adjustment of tension of the connecting cord 13. However, such adjustment is inconvenient and time-consuming to perform, which is disadvantageous for avalanche rescue.

### SUMMARY OF THE INVENTION

An object of the present invention is to provide a collapsible tubular rod which can be assembled and adjusted easily and quickly.

According to this invention, the collapsible tubular rod includes a socket body extending in a lengthwise direction to terminate at first and second ends, and having an inner friction surface which is adjacent to the first end, and which surrounds a lengthwise axis to define an insert bore. A tubular rod body is coaxially coupled with the second end, and includes a plurality of tubular rod segments configured to be end-to-end engageable such that the tubular rod body is convertible between a collapsed state in which the tubular rod segments are juxtaposable with each other so as to permit compact packing, and an assembled state in which the tubular rod segments are coaxially and successively engaged with each other so as to be of an in-line arrangement. A connecting cord is led through the insert bore and the tubular rod segments along the lengthwise axis, and has a fixed end secured to the remotest one of the tubular rod segments relative to the socket body, and a pulling end that is disposed outwardly of the first end such that, upon manual pulling of the pulling end, the connecting cord is transformed from an untensioned state to a tensioned state so as to convert the tubular rod body from the collapsed state to the assembled state. A releasably clamping member has a radially expandable tubular plug and an actuated end. The radially expandable tubular plug is movably fitted in the insert bore, and has an interior expandable clamping surface that is disposed to grip the connecting cord in a normal position, and an exterior expandable friction surface that is opposite to the interior expandable clamping surface in radial directions. The exterior expandable friction surface is configured to mate with, and be axially movable relative to the inner friction surface such that, when the radially expandable tubular plug is moved away from the second end, the interior expandable clamping surface is displaced from the normal position to an expanded position where the connecting cord is set free to pass therethrough so as to permit tension adjustment of the connecting cord. The actuated end is disposed opposite to the radially expandable tubular plug in the lengthwise direction, and has an axially extending passage for passage of the connecting cord therethrough. An actuator is disposed to be coupled to the actuated end so as to actuate the radially expandable tubular plug to displace from the normal position to the expanded position. A biasing member is disposed to bias the radially expandable tubular plug toward the normal position.

By means of axial or radial movement of the actuator, the radially expandable tubular plug is moved to the expanded position to permit tension adjustment of the connecting cord.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a fragmentary schematic view of a conventional collapsible avalanche probe;

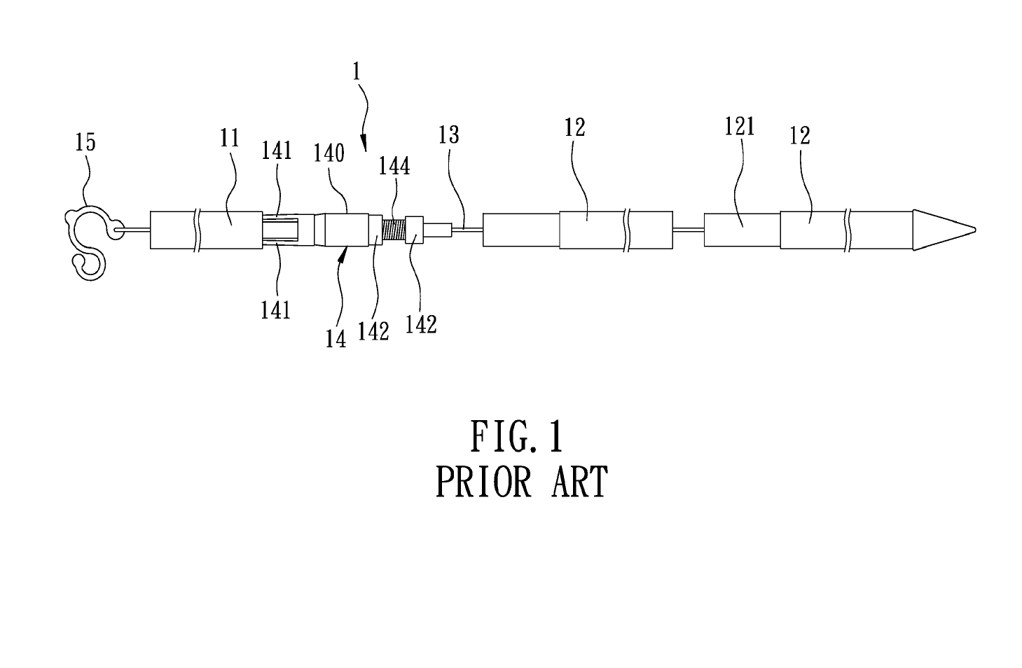

FIG. 2 is an exploded perspective view of a portion of the first embodiment of a collapsible tubular rod according to this invention;

FIG. 3 is a sectional view of the portion of the first embodiment, showing a releasably clamping member in a normal position;

FIG. 4 is a sectional view showing the releasably clamping member in an expanded position;

FIG. 5 is a fragmentary schematic view of the first embodiment in an assembled state;

FIG. 6 is an exploded perspective view of a portion of the second embodiment of a collapsible tubular rod according to this invention;

FIG. 7 is a sectional view of the portion of the second embodiment, showing a releasably clamping member in a normal position; and

FIG. 8 is a sectional view showing the releasably clamping member in an expanded position.

### DETAILED DESCRIPTION OF THE PREFERRED EMBODIMENTS

Before the present invention is described in greater detail, it should be noted that same reference numerals have been used to denote like elements throughout the specification.

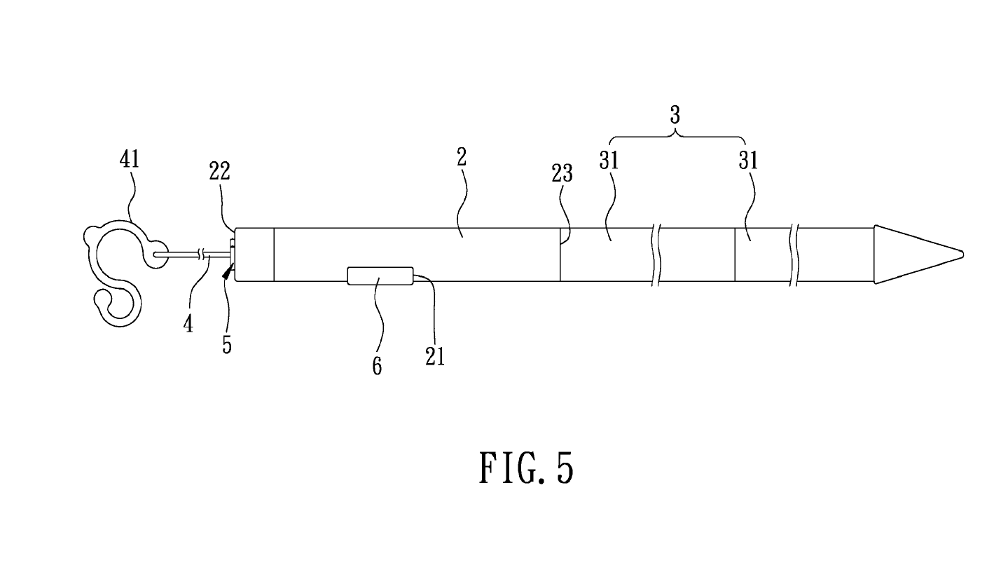

Referring to FIG. 5, the first embodiment of a collapsible tubular rod according to the present invention is shown to comprise a socket body 2, a tubular rod body 3, a connecting cord 4, a releasably clamping member 5, an actuator 6, and a biasing member 7.

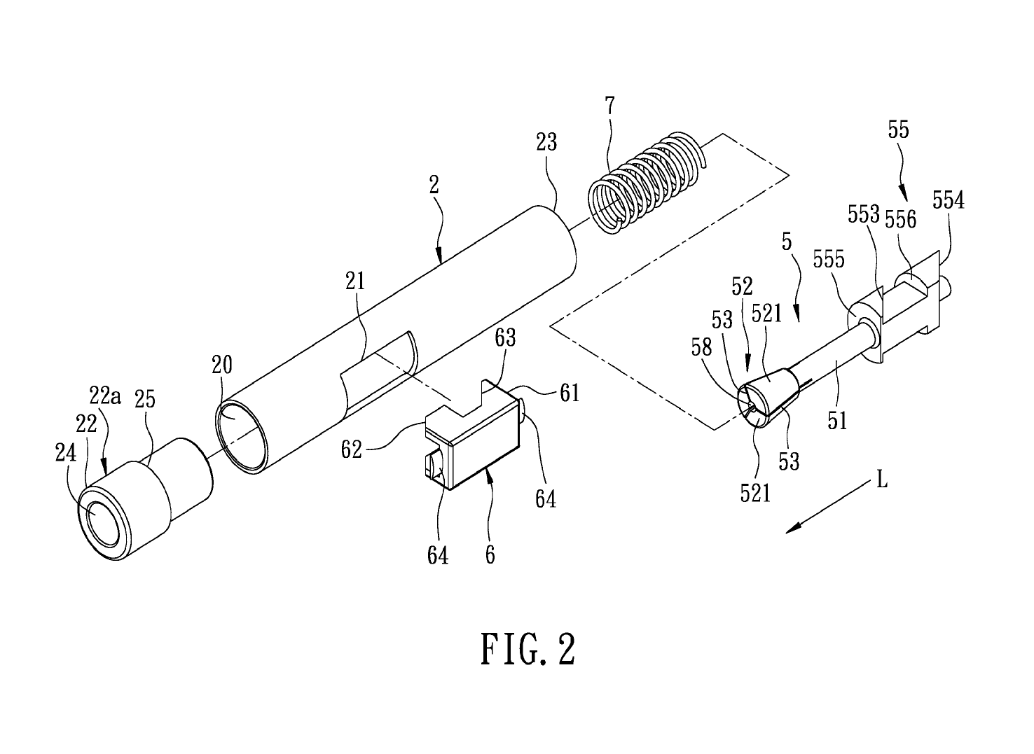

With reference to FIGS. 2 to 4, the socket body 2 extends in a lengthwise direction (L) to terminate at first and second ends 22, 23. In this embodiment, a tubular cap (22a) has an end which serves as the first end 22, and an inner friction surface 24 which is adjacent to the first end 22, and which surrounds a lengthwise axis to define an insert bore 241. Specifically, the inner friction surface 24 has proximate and distal regions (24a, 24b) relative to the first end 22, and is configured to gradually converge from the proximate region (24a) to the distal region (24b) so as to be of a frusto-conical shape. The socket body 2 has a cavity 20 which extends axially from the insert bore 241, and which has a larger dimension than that of the insert bore 241 so as to form an annular shoulder 25 therebetween. The socket body 2 further has an opening 21 extending radially to communicate the cavity 20.

The tubular rod body 3, as shown in FIG. 5, is coaxially coupled with the second end 23, and includes a plurality of tubular rod segments 31 configured to be end-to-end engageable such that the tubular rod body 3 is convertible between a collapsed state in which the tubular rod segments 31 are juxtaposable with each other so as to permit compact packing, and an assembled state (as shown in FIG. 5) in which the tubular rod segments 31 are coaxially and successively engaged with each other so as to be of an in-line arrangement.

The connecting cord 4 is led through the socket body 2 and the tubular rod body 3 along the lengthwise axis, and which has a fixed end secured to the remotest one of the tubular rod segments 31 (e.g., a probe tip of an avalanche probe) relative to the socket body 2, and a pulling end 41 that is disposed outwardly of the first end 22. When the pulling end 41 is pulled manually, the connecting cord 4 is transformed from an untensioned state to a tensioned state so as to convert the tubular rod body 3 from the collapsed state to the assembled state.

The releasably clamping member 5 has a radially expandable tubular plug 52, an actuated end 55, and a tubular shank 51.

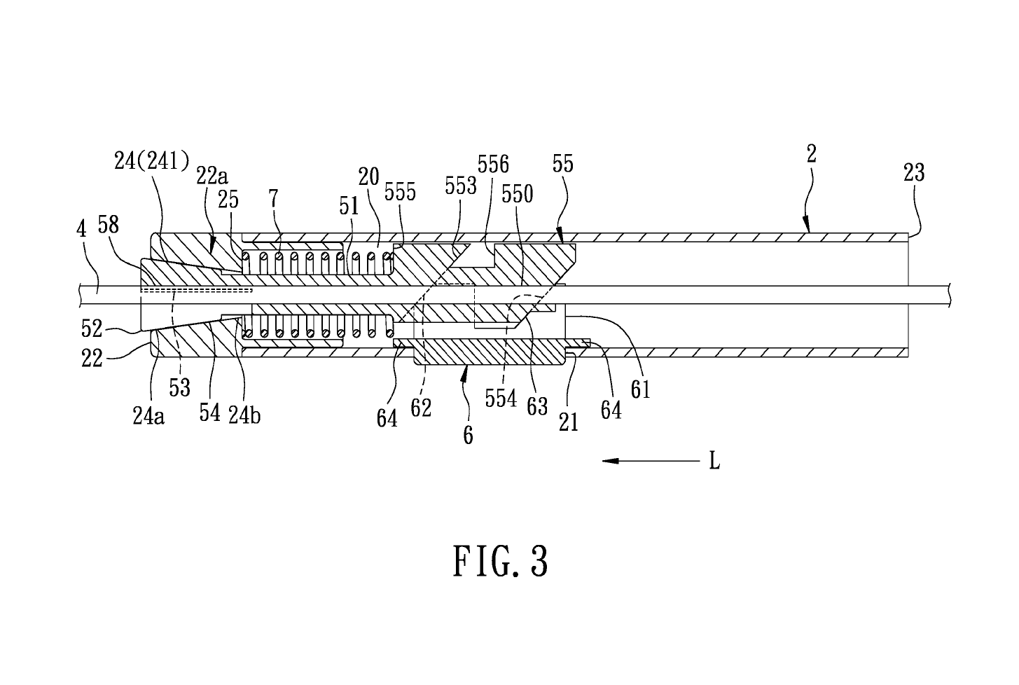

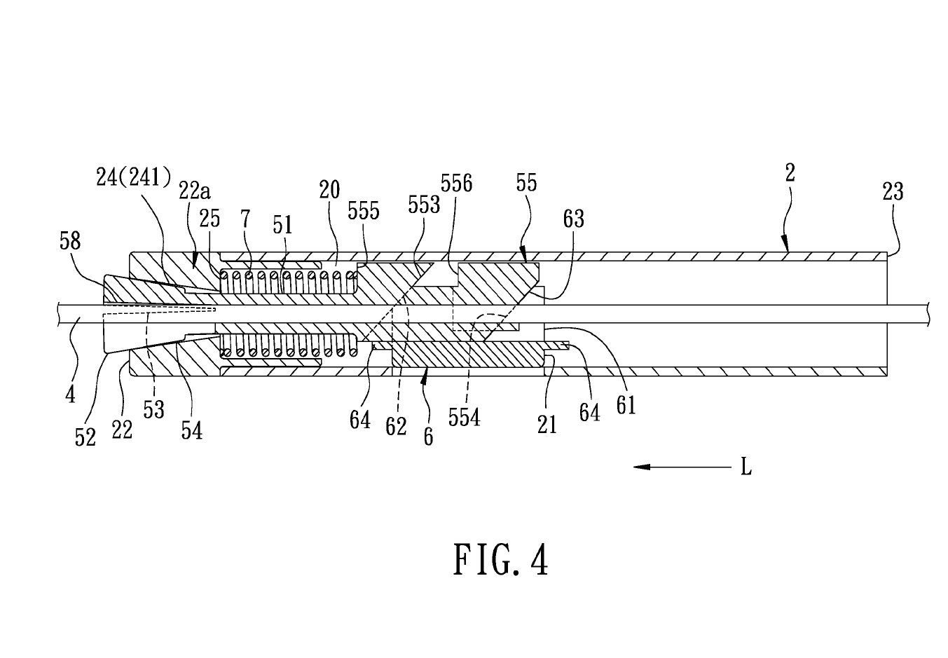

The radially expandable tubular plug 52 is movably fitted in the insert bore 241, and has an interior expandable clamping surface 58 which is disposed to grip the connecting cord 4 in a normal position, and an exterior expandable friction surface 54 which is opposite to the interior expandable clamping surface 58 in radial directions, and which is configured to mate with, and be axially movable relative to the inner friction surface 24. When the radially expandable tubular plug 52 is moved away from the second end 23, the interior expandable clamping surface 58 is displaced from the normal position (as shown in FIG. 3) to an expanded position (as shown in FIG. 4) where the connecting cord 4 is set free to pass therethrough so as to permit tension adjustment of the connecting cord 4. Particularly, the radially expandable tubular plug 52 has a plurality of elastically deformable jaws 521 which are angularly spaced apart from one another by a plurality of gaps 53 that extend in the lengthwise direction (L), and which have a plurality of interior surface segments that cooperatively serve as the interior expandable clamping surface 58, and a plurality of exterior surface segments that cooperatively serve as the exterior expandable friction surface 54.

The actuated end 55 is disposed opposite to the radially expandable tubular plug 52 in the lengthwise direction, and has an axially extending passage 550 for passage of the connecting cord 4 therethrough. The actuated end 55 has two mating friction surface regions 553, 554 inclined relative to the lengthwise axis. The tubular shank 51 interconnects the radially expandable tubular plug 52 and the actuated end 55, and cooperates with the actuated end 55 to define an abutment surface 555. Moreover, the actuated end 55 further has an actuator abutting surface 556 disposed between the mating friction surface regions 553, 554.

The actuator 6 is disposed on and movable relative to the socket body 2 in the radial direction, and has an actuating region 61 which extends through the opening 21 to terminate at two inward actuating surface regions 62, 63. The inward actuating surface regions 62, 63 confront and are matingly and slidably engaged with the mating friction surface regions 553, 554, respectively. Thus, upon the radial movement of the actuator 6, the actuated end 55 is moved in the lengthwise direction to displace the radially expandable tubular plug 52 from the normal position to the expanded position. Further, the actuator 6 has two stops 64 which are disposed to be brought into abutment with the actuated end 55 so as to limit the extent of the radial movement of the actuator 6. Besides, the actuating region 61 is in full abutting engagement with the actuator abutting surface 556 when the radially expandable tubular plug 52 reaches the expanded position.

The biasing member 7 is a coil spring 7 which surrounds the tubular shank 51 and which abuts against the annular shoulder 25 and the abutment surface 555 to bias the radially expandable tubular plug 52 toward the normal position.

As illustrated, by means of a manually pressing movement of the actuator 6, the radially expandable tubular plug 52 is moved to the expanded position to permit tension adjustment of the connecting cord 4. When the manual force is removed, the radially expandable tubular plug 52 is moved back to the normal position by the biasing action of the biasing member 7 so as to grip the connecting cord 4.

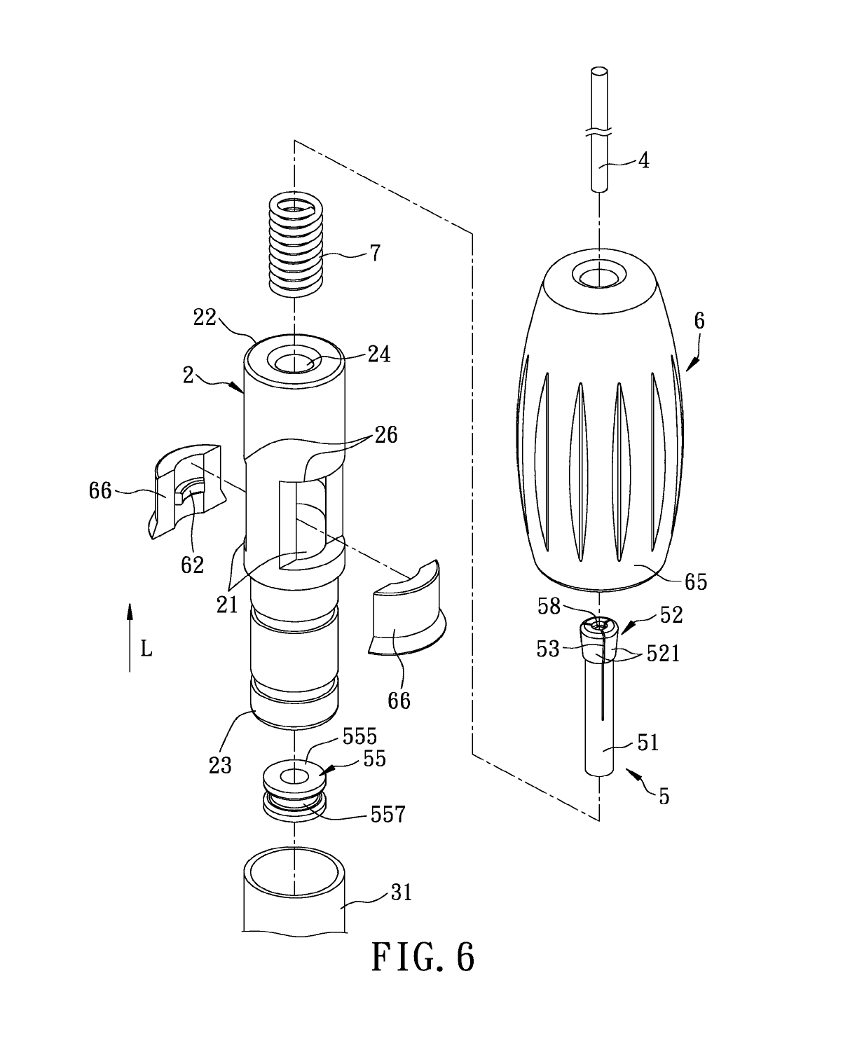

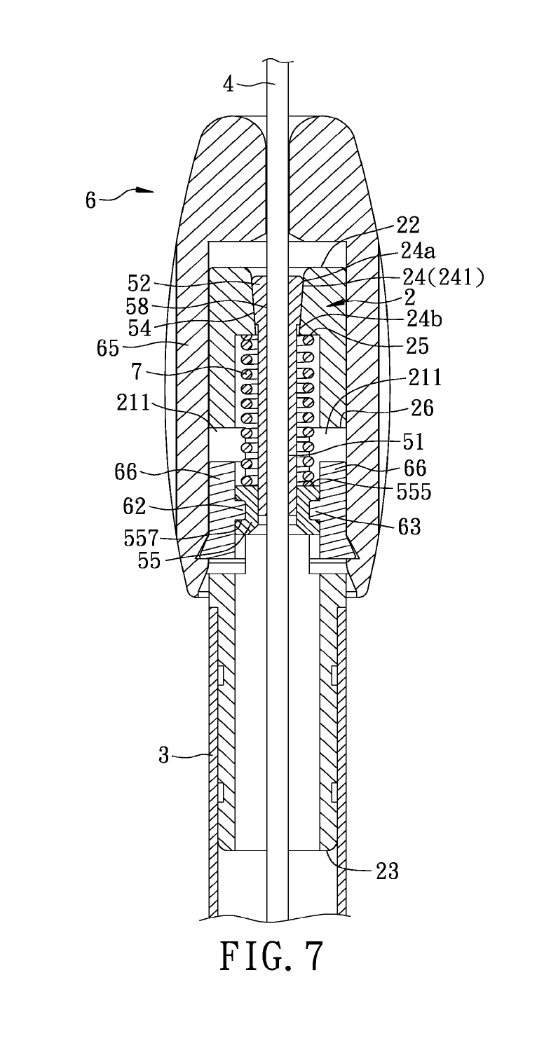

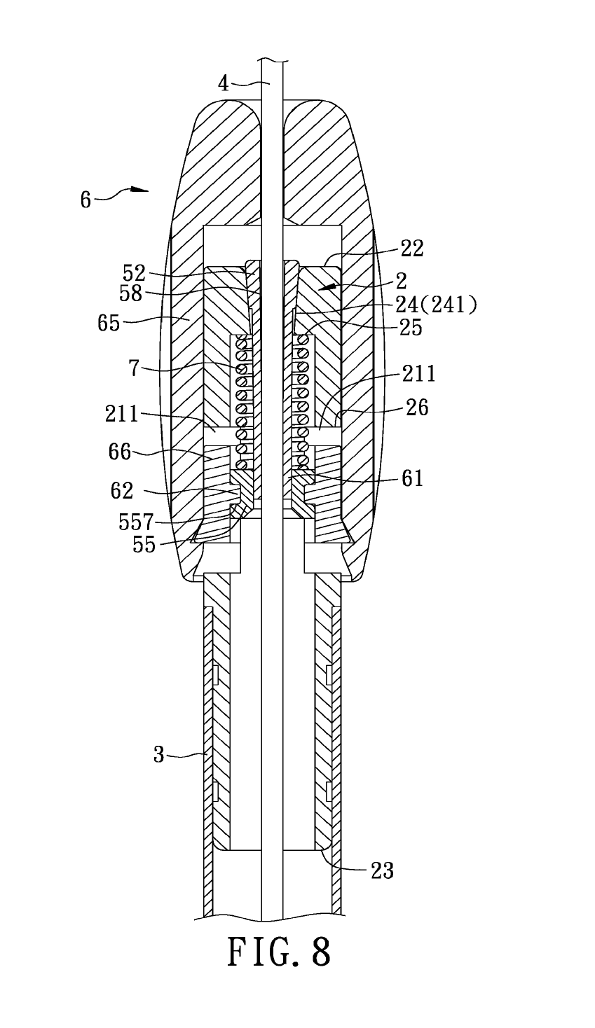

Referring to FIGS. 6 to 8, the second embodiment of the collapsible tubular rod according to this invention is similar to the first embodiment in structure. In the second embodiment, the opening 21 has a pair of slots 211 elongated in the lengthwise direction (L) to terminate at stop edges 26, respectively. The actuated end 55 of the releasably clamping member 5 is sleeved on and secured to the tubular shank 51 so as to form an abutment surface 555, and has an annular groove 557. The actuator 6 includes a sleeve 65 mounted on and slidable relative to the socket body 2 along the lengthwise axis, and a pair of force transmitting blocks 66 which are mounted respectively in the slots 211, which are fittingly engaged with the sleeve 65, and which respectively have the inward actuating surface regions 62, 63 engaged in the annular groove 557 to transmit the axial movement of the sleeve 65 to the actuated end 55 so as to displace the radially expandable tubular plug 52 from the normal position to the expanded position. The extent of the axial movement of the force transmitting blocks 66 is limited by the stop edges 26.

Accordingly, by means of manual axial movement of the sleeve 65, the radially expandable tubular plug 52 is moved to the expanded position to permit tension adjustment of the connecting cord 4. Therefore, the collapsible tubular rod of this invention is suitable to be used for avalanche rescue where an avalanche probe that is capable of quickly and easily recovered into an in-line arrangement is required.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A collapsible tubular rod capable of being recovered into an in-line arrangement, comprising:
a socket body extending in a lengthwise direction to terminate at first and second ends, and having an inner friction surface which is adjacent to said first end, and which surrounds a lengthwise axis to define an insert bore;
a tubular rod body which is coaxially coupled with said second end, and which includes a plurality of tubular rod segments configured to be end-to-end engageable such that said tubular rod body is convertible between a collapsed state in which said tubular rod segments are juxtaposable with each other so as to permit compact packing, and an assembled state in which said tubular rod segments are coaxially and successively engaged with each other so as to be of the in-line arrangement;
a connecting cord which is led through said insert bore and said tubular rod segments along the lengthwise axis, and which has a fixed end secured to the remotest one of said tubular rod segments relative to said socket body, and a pulling end that is disposed outwardly of said first end such that, upon manual pulling of said pulling end, said connecting cord is transformed from an untensioned state to a tensioned state so as to convert said tubular rod body from the collapsed state to the assembled state;
a releasably clamping member having
a radially expandable tubular plug which is movably fitted in said insert bore, and which has an interior expandable clamping surface that is disposed to grip said connecting cord in a normal position, and an exterior expandable friction surface that is opposite to said interior expandable clamping surface in radial directions, and that is configured to mate with, and be axially movable relative to said inner friction surface such that, when said radially expandable tubular plug is moved away from said second end, said interior expandable clamping surface is displaced from the normal position to an expanded position, where said connecting cord is set free to pass therethrough so as to permit tension adjustment of said connecting cord, and
an actuated end disposed opposite to said radially expandable tubular plug in the lengthwise direction, and having an axially extending passage for passage of said connecting cord therethrough;
an actuator disposed to be coupled to said actuated end so as to actuate said radially expandable tubular plug to displace from the normal position to the expanded position; and
a biasing member disposed to bias said radially expandable tubular plug toward the normal position.

2. The collapsible tubular rod as claimed in claim 1, wherein said inner friction surface has proximate and distal regions relative to said first end, and is configured to converge from said proximate region to said distal region so as to be of a frusto-conical shape.

3. The collapsible tubular rod as claimed in claim 2, wherein said radially expandable tubular plug has a plurality of elastically deformable jaws which are angularly spaced apart from each other by a plurality of gaps extending in the lengthwise direction, and which have a plurality of interior surface segments that cooperatively serve as said interior expandable clamping surface, and a plurality of exterior surface segments that cooperatively serve as said exterior expandable friction surface.

4. The collapsible tubular rod as claimed in claim 1, wherein said socket body has a cavity which extends axially from said insert bore, and which has a larger dimension than that of said insert bore so as to form an annular shoulder therebetween, said releasably clamping member having a tubular shank which interconnects said radially expandable tubular plug and said actuated end, and which cooperates with said actuated end to define an abutment surface, said biasing member being a coil spring which surrounds said tubular shank and which abuts against said annular shoulder and said abutment surface.

5. The collapsible tubular rod as claimed in claim 4, wherein said socket body has an opening extending radially to communicate said cavity, said actuator being disposed on and movable relative to said socket body in one of the lengthwise and radial directions, and having an actuating region which extends through said opening to terminate at an inward actuating surface region, said inward actuating surface region being coupled to said actuated end to transmit the movement of said actuator to displace said radially expandable tubular plug from the normal position to the expanded position

6. The collapsible tubular rod as claimed in claim 5, wherein said actuated end has a mating friction surface region which confronts and is matingly and slidably engaged with said inward actuating surface region such that, upon movement of said actuator in the radial direction, said actuated end is moved in the lengthwise direction to displace said radially expandable tubular plug.

7. The collapsible tubular rod as claimed in claim 6, wherein said actuator has a stop which is disposed to be brought into abutment with said actuated end so as to limit the extent of the movement of said actuator when said actuator is moved in the radial direction.

8. The collapsible tubular rod as claimed in claim 5, wherein said actuator includes a sleeve mounted on and slidable relative to said socket body along the lengthwise axis, and a pair of force transmitting blocks which are disposed in said opening, and which are configured to transmit the axial movement of said sleeve to said actuated end so as to displace said radially expandable tubular plug from the normal position to the expanded position.

9. The collapsible tubular rod as claimed in claim 8, wherein said opening has a pair of slots elongated in the lengthwise direction to terminate at stop edges, respectively, such that said force transmitting blocks are mounted respectively in said slots and such that the extent of movement of said force transmitting blocks is limited by said stop edges.
